(19) United States
(12) Patent Application Publication
(10) Pub. No.: US 2018/0133821 A1
(43) Pub. Date: May 17, 2018

(54) CHAINSAW SHARPENING STAND

(71) Applicant: RICHARD HAWKINS, LESTERVILLE, MO (US)

(72) Inventor: RICHARD HAWKINS, LESTERVILLE, MO (US)

(21) Appl. No.: 15/351,705

(22) Filed: Nov. 15, 2016

(51) Int. Cl. B23D 63/16

(52) U.S. Cl. CPC B23D 63/166

(57) ABSTRACT

Disclosed is a chainsaw workbench for safely controlling a chainsaw during sharpening of blades thereof. The chainsaw workbench includes a base placed on a fixed support; a first elevation platform attached to the base to rest the handle of the chainsaw; a second elevation platform attached to the base to rest the handle of the chainsaw; a first mount extending upwards from the base along the edge of the first elevation platform; and a second mount extending upwards from the base along the edge of the second elevation platform, wherein the distance between the first mount and the second mount is sufficient to receive the blade of the chainsaw; wherein the chainsaw blade rests on the first mount and the second mount. Further, the chainsaw workbench includes a tool box placed on the base to store tools. Furthermore, the chainsaw workbench includes a first screw to tight the first mount; and a second screw to tight the second mount.

### BACKGROUND OF THE INVENTION

### 1. Field of the Invention

The present invention relates generally to chainsaw workbenches, and more particularly relates to chainsaw workbenches adapted to be deployed for safely controlling of chainsaws for cutting and sawing diverse items in a safe and efficient manner.

### 2. Description of Related Art

Conventional chain saws are powered by small gasoline or electric engines. Modern chain saws are in widespread use, particularly for cutting or trimming trees and large branches, or for cutting fireplace wood. The modern frequency and intensity of storms, including wind storms and tornadoes, and the resultant damages to trees and tree limbs, accentuates the value of a modern chain saw as a necessary household appliance. Chain saw use for cutting home firewood for heating has increased demonstrably as well. Chain saws, after all that work, need to be sharpened constantly to maintain their proper performance.

Chain saws comprise a powered blade that revolves about a flat, elongated bar or “blade” that supports chain rotation. Numerous rigid, sharpened teeth supported by the revolving chain vigorously cut through work pieces such as branches, trees, logs and the like. Many conventional chain saws are lightweight and portable. The handle by which the saw can be lifted and manipulated usually includes safety features such as automatic shut off switches. Various types of safety guards known in the art exist as well.

Many portable benches are known for controlling a chainsaw when working on the chainsaw. Therefore, there is a need of a chainsaw workbench adapted to be deployed for safely controlling of chainsaws for cutting and sawing diverse items in a safe and efficient manner.

### SUMMARY OF THE INVENTION

In accordance with the teachings of the present invention, a chainsaw workbench adapted to be deployed for safely controlling of chainsaws during blade sharpening, or working on the device in a safe and efficient manner is provided.

An object of the present invention is to provide a chainsaw workbench for safely controlling for re-sharpening the blades of thereof. The chainsaw workbench includes a base placed on a fixed support, a first elevation platform and a second elevation platform attached to the base to rest the handle of the chainsaw.

The chainsaw workbench further includes a first mount extending upwards from the base station along the edge of the first elevation platform, a second mount extending upwards from the base along the edge of the second elevation platform. The distance between the first mount and the second mount is sufficient to receive the blade of the chainsaw. The chainsaw blade rests on the first mount and the second mount.

Another project of the present invention is to provide the chainsaw workbench tool box placed on the base to store tools. Further, the chainsaw workbench includes a first screw to tight the first mount and a second screw to tight the second mount. The first screw and the second screw allow the user to firmly secure the blade.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a top perspective view of a chainsaw workbench for safely controlling of chainsaws during sharpening in accordance with a preferred embodiment of the present invention; and

FIG. 2 illustrates a side view of a chainsaw workbench in accordance with a preferred embodiment of the present invention.

### DETAILED DESCRIPTION OF ILLUSTRATED INVENTION

While this technology is illustrated and described in a preferred embodiment a chainsaw workbench for safely controlling of chainsaws for cutting and sawing of items may be produced in various shapes, sizes, colors, and configuration. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

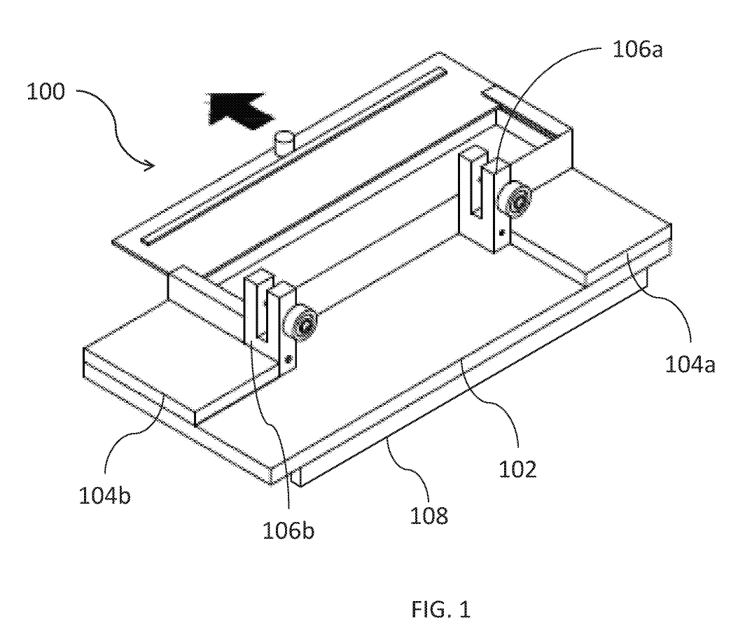

FIG. 1 illustrates a top perspective view of a chainsaw workbench 100 for safely controlling of a chainsaw during sharpening activities in accordance with a preferred embodiment of the present invention. The chainsaw workbench 100 includes a base 102 to be placed on a fixed support; a first elevation platform 104a and a second elevation platform 104b are attached on the base 102 to rest the engine and handle that is coupled to the engine of the chainsaw.

The chainsaw workbench 100 includes a first mount 106a extending upwards from the base 102 along the edge of the first elevation platform 104a and a second mount 106b extending upwards from the base 102 along the edge of the second elevation platform 104b. The distance in between the first mount 106a and the second mount 106b is sufficient enough to receive the blade of the chainsaw. The blade of the chainsaw rests on the first mount 106a and the second mount 106b.

Examples of the fixed support include but not limited to a table, floor, or any other flat surface to firmly hold the chainsaw workbench. In a preferred embodiment of the present invention, the base 102 and the first elevation platform and the second elevation platform are made up of wood. To help the bench 100 stabilize on a table there is a stabilizing lip 108 extending downward so that it will catch along an edge of the table in a known way that is understood by those skilled in the art.

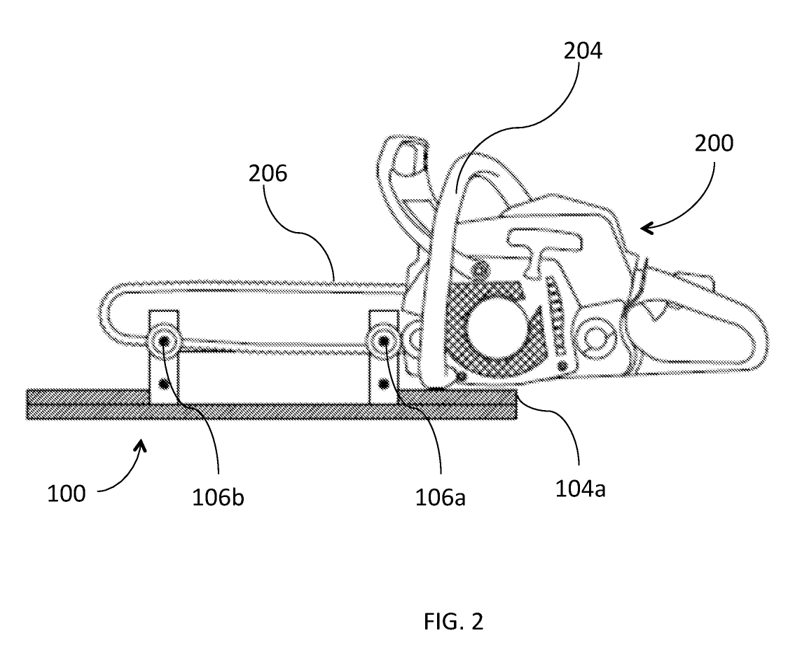

In another preferred embodiment of the present invention, the chainsaw workbench 100 may include a tool box (not shown) placed on the base to store tools required for sharpening the blades of the chainsaw. Examples of the items include but not limited to branches, trees, logs, kitchen knife, files, gauges, and other utility tools etc. The blade and chainsaw are shown and explained in FIG. 2 of the present invention.

FIG. 2 illustrates a side view of a chainsaw workbench 100 for safely controlling of the chainsaw 200 during sharpening activities in accordance with a preferred embodiment of the present invention. The chainsaw handle 204 rests on the first elevation platform 104a.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

I/We claim as follows:

1. A chainsaw workbench for safely sharpening blades of the chainsaw, comprising:
a) a base placed on a fixed support;
b) a first elevation platform attached to the base to rest a handle of the chainsaw;
c) a second elevation platform attached to the base to rest the handle of the chainsaw;
d) a first mount extending upwards from the base along the edge of the first elevation platform; and
e) a second mount extending upwards from the base along the edge of the second elevation platform, wherein the distance between the first mount and the second mount is sufficient to receive the blade of the chainsaw;
f) wherein the chainsaw blade rests on the first mount and the second mount, and the engine of the chainsaw rests on the first elevation platform.

2. The chainsaw workbench according to claim 1 further comprising:
a) a first screw to tight the first mount; and
b) a second screw to tight the second mount.

3. A method for safely sharpening blades of a chainsaw, comprising:
a) providing a chainsaw workbench, having:
i) a base placed on a fixed support;
ii) a first elevation platform attached to the base to rest a handle of the chainsaw;
iii) a second elevation platform attached to the base to rest the handle of the chainsaw;
iv) a first mount extending upwards from the base along the edge of the first elevation platform; and
v) a second mount extending upwards from the base along the edge of the second elevation platform, wherein the distance between the first mount and the second mount is sufficient to receive the blade of the chainsaw; and
b) resting a chainsaw on the workbench such that the chainsaw blade rests on the first mount and the second mount, and the engine of the chainsaw rests on the first elevation platform.

4. method according to claim 4, further comprising:
a) a first screw to tight the first mount; and
b) a second screw to tight the second mount.
